(19) United States
(12) Patent Application Publication
(10) Pub. No.: US 2026/0193507 A1
(43) Pub. Date: Jul. 9, 2026

(54) COMPOSITION CONTAINING (METH)ACRYLIC POLYMER AND METAL PARTICLES

(71) Applicant: Resonac Corporation, Minato-ku, Tokyo (JP)

(72) Inventors: Naoki FURUKAWA, Minato-ku, Tokyo (JP); Yuki NAKAMURA, Minato-ku, Tokyo (JP); Hiroshi YOKOTA, Minato-ku, Tokyo (JP)

(21) Appl. No.: 18/861,591

(22) PCT Filed: Jun. 29, 2023
(86) PCT No.: PCT/JP2023/024270

§ 371 Date: Oct. 30, 2024

(30) Foreign Application Priority Data
Jul. 8, 2022 (JP) 2022-110442

(51) Int. Cl. C09K 5/14; C08F 290/04; C08K 3/08; F28F 13/00

(52) U.S. Cl. CPC C09K 5/14; C08F 290/046; C08K 3/08; C08K 2003/0806; C08K 2201/001; F28F 2013/001

(57) ABSTRACT

A composition containing a (meth)acrylic polymer having (meth)acryloyl groups at both ends of a poly(meth)acrylate chain, and metal particles. An article including a heat source and a cured product of the composition containing a (meth)acrylic polymer and metal particles, wherein the cured product is in thermal contact with the heat source.

### TECHNICAL FIELD

The present invention relates to a composition containing a (meth)acrylic polymer and metal particles.

### BACKGROUND ART

In electronic components such as processors and power modules, batteries for electric vehicles, and the like, heat generation is accompanied during use. In order to protect such parts from heat, means for efficiently dissipating the generated heat is required. A thermally conductive material (may be referred to as heat dissipation material) called a thermal interface material (TIM) is a material provided between a heat source and a heat dissipation member such as a heat sink, and this material reduces heat resistance between a heat source and a heat dissipation member and promotes heat conduction from the heat source. Since the heat generated from the heat source is efficiently conducted to a cooling member via the TIM, heat is easily dissipated from the heat dissipation member.

As the thermally conductive material, many liquid materials are known, which are also referred to as heat-dissipating grease or thermally conductive grease. However, when a liquid thermally conductive grease is used, dripping after application, or a pump-out phenomenon in which due to deformation of members to which the thermally conductive grease is applied, the grease is pushed out from between the members, may occur. In order to solve such a problem, a thermally conductive material formed in a solid shape as is the case with a sheet may be used. As a thermally conductive material in a solid form, for example, a thermally conductive sheet containing thermally conductive particles and a cured product of a polymerizable compound has been considered.

Patent Literature 1 describes an acrylic thermally conductive composition containing a monofunctional (meth)acrylate, a polyfunctional (meth)acrylate, a photopolymerization initiator, thermally conductive particles, a plasticizer, and a thiol compound, and a thermally conductive sheet having a thermally conductive resin layer obtained by photocuring the acrylic thermally conductive composition.

### CITATION LIST

### Patent Literature

Patent Literature 1: Japanese Unexamined Patent Publication No. 2015-221863

### SUMMARY OF INVENTION

### Technical Problem

It is preferable that thermally conductive materials have high heat resistance so as to be able to cope with a variety of heat sources. However, according to the investigations of the inventors of the present invention, in a case where metal particles are used as thermally conductive particles, it is difficult to realize high heat resistance.

It is an object of the present invention to provide a composition capable of forming a cured product having excellent heat resistance.

### Solution to Problem

The present inventors found that in a case where metal particles are used, when a (meth)acrylic polymer having (meth)acryloyl groups at both ends of a poly(meth)acrylate chain is used together, a composition capable of forming a cured product having excellent heat resistance is obtained.

According to some aspects, the present invention provides the following [1] to [9].
[1] A composition containing:
a (meth)acrylic polymer having (meth)acryloyl groups at both ends of a poly(meth)acrylate chain; and
metal particles.
[2] The composition according to [1], wherein the (meth)acrylic polymer has a glass transition temperature of −40° C. or lower.
[3] The composition according to [1] or [2], wherein the (meth)acrylic polymer has a weight average molecular weight of 19000 or more.
[4] The composition according to any one of [1] to [3], wherein a viscosity at 23° C. of the (meth)acrylic polymer is 200 Pa·s or greater.
[5] The composition according to any one of [1] to [4], wherein the composition further contains a compound having one (meth)acryloyl group, the compound having one (meth)acryloyl group contains a compound having one (meth)acryloyl group and a carboxyl group, and a content of the compound having one (meth)acryloyl group and a carboxyl group is 8% by mass or less based on a total mass of the compound having one (meth)acryloyl group.
[6] The composition according to any one of [1] to [5], wherein the metal particles are silver particles.
[7] The composition according to any one of [1] to [6], wherein the composition is used for forming a heat dissipation material.
[8] A cured product of the composition according to any one of [1] to [7].
[9] An article containing: a heat source; and the cured product according to [8] in thermal contact with the heat source.

### Advantageous Effects of Invention

According to an aspect of the present invention, a composition capable of forming a cured product having excellent heat resistance can be provided.

### BRIEF DESCRIPTION OF DRAWINGS

FIG. 1 is a schematic cross-sectional view illustrating an embodiment of an article.

FIG. 2 is a schematic cross-sectional view illustrating another embodiment of the article.

### DESCRIPTION OF EMBODIMENTS

Embodiments of the present invention will be described in detail below. Incidentally, the present invention is not intended to be limited to the following embodiments.

The term “(meth)acryloyl” according to the present specification means “acryloyl” and “methacryloyl” corresponding thereto, and the same also applies to similar expressions such as “(meth)acrylate” and “(meth)acryl”.

The weight average molecular weight (Mw), the number average molecular weight (Mn), and the ratio of the weight average molecular weight and the number average molecular weight (Mw/Mn) according to the present specification means values measured using gel permeation chromatography (GPC) under the following conditions and determined by using polystyrene as a standard substance.
Measuring instrument: HLC-8320GPC (product name, manufactured by Tosoh Corporation)
Analytical column: TSKgel SuperMultipore HZ-H (three pieces connected together) (product name, manufactured by Tosoh Corporation)
Guard column: TSKguardcolumn SuperMP (HZ)-H (product name, manufactured by Tosoh Corporation)
Eluent: THE
Measurement temperature: 25° C.

The composition according to an embodiment of the present invention contains a (meth)acrylic polymer having (meth)acryloyl groups at both ends of a poly(meth)acrylate chain (hereinafter, also simply referred to as “(meth)acrylic polymer”) and metal particles. Since this composition contains a (meth)acrylic polymer, a cured product of the composition has excellent heat resistance. Furthermore, according to an embodiment, since the composition contains a (meth)acrylic polymer, a cured product of the composition may have low elasticity.

From the viewpoint that the cured product has lower elasticity and more excellent elongation, the glass transition temperature (Tg) of the (meth)acrylic polymer may be 0° C. or lower, and is preferably −10° C. or lower, more preferably −20° C. or lower, even more preferably −30° C. or lower, and particularly preferably −40° C. or lower. The Tg of the (meth)acrylic polymer may be −70° C. or higher, −60° C. or higher, or −55° C. or higher. The glass transition temperature means a value measured by differential scanning calorimetry.

The (meth)acrylic polymer may be liquid at 23° C. In this case, the viscosity at 23° C. of the (meth)acrylic polymer may be 1000 Pa·s or less, 900 Pa·s or less, or 800 Pa·s or less, from the viewpoint of facilitating application on a coating surface and from the viewpoint of enhancing the adhesiveness of the cured product to the coating surface. From the viewpoint that the cured product has more excellent elongation, the viscosity at 23° C. of the (meth)acrylic polymer may be 1 Pa·s or more, 50 Pa·s or more, 100 Pa·s or more, 200 Pa·s or more, 300 Pa·s or more, 400 Pa·s or more, or 500 Pa·s or more.

In the present specification, the viscosity means a value measured based on JIS Z8803 and specifically means a value measured by using an E type viscometer (for example, PE-80L manufactured by Toki Sangyo Co., Ltd.). Incidentally, calibration of the viscometer can be carried out based on JIS Z8809-JS14000.

From the viewpoint that the cured product has lower elasticity and excellent elongation, the weight average molecular weight of the (meth)acrylic polymer is preferably 3000 or more, 4000 or more, 5000 or more, 6000 or more, 7000 or more, 8000 or more, 9000 or more, 10000 or more, 11000 or more, 12000 or more, 13000 or more, 15000 or more, 19000 or more, 21000 or more, 23000 or more, or 25000 or more. From the viewpoint of facilitating adjustment of the viscosity of the composition, the weight average molecular weight of the (meth)acrylic polymer is preferably 150000 or less, 120000 or less, 100000 or less, 80000 or less, 60000 or less, or 40000 or less.

The two (meth)acryloyl groups present at both ends in the (meth)acrylic polymer may be each independently an acryloyl group or a methacryloyl group. The poly(meth)acrylate chain contains a (meth)acrylic acid ester ((meth)acrylate) as a monomer unit. The (meth)acrylic acid ester as a monomer unit may have a hydrocarbon group such as an alkyl group, an aryl group (a phenyl group, a toluyl group, or the like), or a benzyl group; an organic group having an oxygen atom, such as an alkoxy group, a hydroxyl group, a carboxyl group, or a glycidyl group; a group having a nitrogen atom, such as an amino group or a nitrile group; or the like.

The hydrocarbon group may be chain-shaped, or may have a ring (for example, an aromatic ring). The number of carbon atoms of the hydrocarbon group may be, for example, 1 or more or may be 18 or less. The (meth)acrylic acid ester having a hydrocarbon group may be an alkyl (meth)acrylate, an aryl (meth)acrylate, a benzyl (meth)acrylate, or the like. Examples of the alkyl (meth)acrylate include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-pentyl (meth)acrylate, n-hexyl (meth)acrylate, n-heptyl (meth)acrylate, n-octyl (meth)acrylate, 2-ethylhexyl (meth)acrylate, 2-propylheptyl (meth)acrylate, nonyl (meth)acrylate, decyl (meth)acrylate, isodecyl (meth)acrylate, dodecyl (meth)acrylate, and octadecyl (meth)acrylate.

Examples of the (meth)acrylic acid ester having an organic group having an oxygen atom include 2-methoxyethyl (meth)acrylate, 3-methoxybutyl (meth)acrylate, 2-hydroxyethyl (meth)acrylate, 2-hydroxypropyl (meth)acrylate, 4-hydroxybutyl (meth)acrylate, carboxyl (meth)acrylate, and glycidyl (meth)acrylate.

Examples of the (meth)acrylic acid ester having an organic group having a nitrogen atom include 2-aminoethyl (meth)acrylate and nitrile (meth)acrylate.

From the viewpoint that the cured product has more excellent heat resistance, the content of the (meth)acrylic polymer may be 0.5% by mass or more, 1% by mass or more, or 3% by mass or more, and may be 10% by mass or less, 8% by mass or less, or 6% by mass or less, based on the total mass of the composition.

For the purpose of adjusting the physical properties of the cured product, and the like, the composition may further contain an additional polymerizable compound other than the (meth)acrylic polymer, in addition to the (meth)acrylic polymer (the details will be described below). From the viewpoint that the cured product has more excellent heat resistance, the content of the (meth)acrylic polymer is preferably 5 parts by mass or more, 10 parts by mass or more, 20 parts by mass or more, 30 parts by mass or more, or 35 parts by mass or more, and maybe, for example, 80 parts by mass or less, 70 parts by mass or less, 60 parts by mass or less, 50 parts by mass or less, or 45 parts by mass or less, with respect to 100 parts by mass of the sum of the (meth)acrylic polymer and the additional polymerizable compound (hereinafter, referred to as “total content of the polymerizable components”).

The metal that forms the metal particles may be, for example, silver, gold, copper, or aluminum. From the viewpoint that the cured product has excellent thermal conduction properties, the metal particles are preferably silver particles. The content of the metal in the metal particles is preferably 90% by mass or more, more preferably 95% by mass or more, even more preferably 98% by mass or more, and particularly preferably 99% by mass or more, based on the total mass of the metal particles. The metal particles may be particles consisting essentially of metal only (particles in which essentially 100% by mass of the particles is metal, or particles formed of metal and unavoidable impurities only).

From the viewpoint that the cured product has more excellent thermal conduction properties, the thermal conductivity of the metal particles may be 200 W/(m·K) or greater, 250 W/(m·K) or greater, 300 W/(m·K) or greater, 350 W/(m·K) or greater, or 400 W/(m·K) or greater.

The shape of the metal particles may be a flaky shape, a spherical shape, a lump shape, a dendrite shape, a plate shape, or the like. From the viewpoint that the cured product has more excellent thermal conduction properties, the shape of the metal particles is preferably a flaky shape. As the metal particles, two or more kinds of metal particles having shapes that are different from each other may be used.

From the viewpoint that the cured product has more excellent thermal conduction properties, the average particle size of the metal particles is preferably 1.0 μm or more, 3.0 μm or more, or 5.0 μm or more, and is preferably 16.0 μm or less, 14.0 μm or less, 12.0 μm or less, or 10.0 μm or less. The average particle size of the metal particles can be measured using a laser diffraction type particle size distribution analyzer (laser diffraction method).

The BET specific surface area of the metal particles may be 0.08 m²/g or greater or 0.1 m²/g or greater, and may be 1 m²/g or less, 0.8 m²/g or less, or 0.5 m²/g or less.

From the viewpoint that the cured product has more excellent thermal conduction properties, the content of the metal particles is preferably 60% by mass or more, more preferably 70% by mass or more, and even more preferably 80% by mass or more, based on the total mass of the composition. The content of the metal particles may be 98% by mass or less, 95% by mass or less, or 90% by mass or less, based on the total mass of the composition.

From the viewpoint that the cured product has more excellent thermal conduction properties, the content of the metal particles is preferably 20% by volume or more, more preferably 30% by volume or more, and even more preferably 40% by volume or more, based on the total volume of the composition. The content of the metal particles may be 90% by volume or less, 80% by volume or less, or 70% by volume or less, based on the total volume of the composition.

For the purpose of adjusting the physical properties of the composition and the cured product, and the like, the composition may further contain an additional polymerizable compound that can be copolymerized with the above-mentioned (meth)acrylic polymer.

The additional polymerizable compound may be, for example, a compound having one (meth)acryloyl group. The compound may be, for example, an alkyl (meth)acrylate. The additional polymerizable compound may also be a compound having an aromatic hydrocarbon group, a group containing a polyoxyalkylene chain, a group containing a heterocyclic ring, an alkoxy group, a phenoxy group, a group containing a silane group, a group containing a siloxane bond, a halogen atom, a hydroxyl group, a carboxyl group, an amino group, or an epoxy group, in addition to the one (meth)acryloyl group. When the composition further contains a compound having one (meth)acryloyl group, the physical properties of the cured product, such as thermal conduction properties, can be adjusted.

The alkyl group in the alkyl (meth)acrylate (alkyl group moiety other than the (meth)acryloyl group) may be linear, branched, or cyclic. The number of carbon atoms of the alkyl group may be 1 or more, 3 or more, 5 or more, or 6 or more, and may be 30 or less, 24 or less, 20 or less, 18 or less, 14 or less, or 12 or less. The number of carbon atoms of the alkyl group may be, for example, 1 to 30, 1 to 24, 3 to 18, 5 to 14, or 6 to 12, may be 1 to 11, 1 to 8, 1 to 6, or 1 to 4, or may be 12 to 30, 12 to 28, 12 to 24, 12 to 22, 12 to 18, or 12 to 14.

Examples of an alkyl (meth)acrylate having a linear alkyl group include an alkyl (meth)acrylate having a linear alkyl group having 1 to 11 carbon atoms, and an alkyl (meth)acrylate having a linear alkyl group having 12 to 30 carbon atoms. Examples of the alkyl (meth)acrylate having a linear alkyl group having 1 to 11 carbon atoms include methyl (meth)acrylate, ethyl (meth)acrylate, propyl (meth)acrylate, butyl (meth)acrylate, pentyl (meth)acrylate, n-hexyl (meth)acrylate, n-heptyl (meth)acrylate, octyl (meth)acrylate, nonyl (meth)acrylate, decyl (meth)acrylate, and undecyl (meth)acrylate. Examples of the alkyl (meth)acrylate having a linear alkyl group having 12 to 30 carbon atoms include dodecyl (meth)acrylate (lauryl (meth)acrylate), tetradecyl (meth)acrylate, hexadecyl (meth)acrylate (cetyl (meth)acrylate), octadecyl (meth)acrylate (stearyl (meth)acrylate), docosyl (meth)acrylate (behenyl (meth)acrylate), tetracosyl (meth)acrylate, hexacosyl (meth)acrylate, and octacosyl (meth)acrylate.

Examples of an alkyl (meth)acrylate having a branched alkyl group include an alkyl (meth)acrylate having a branched alkyl group having 1 to 11 carbon atoms, and an alkyl (meth)acrylate having a branched alkyl group having 12 to 30 carbon atoms. Examples of the alkyl (meth)acrylate having a branched alkyl group having 1 to 11 carbon atoms include s-butyl (meth)acrylate, t-butyl (meth)acrylate, isobutyl (meth)acrylate, isopentyl (meth)acrylate, isoamyl (meth)acrylate, isooctyl (meth)acrylate, 2-ethylhexyl (meth)acrylate, isononyl (meth)acrylate, and isodecyl (meth)acrylate. Examples of the alkyl (meth)acrylate having a branched alkyl group having 12 to 30 carbon atoms include isomyristyl (meth)acrylate, 2-propylheptyl (meth)acrylate, isoundecyl (meth)acrylate, isododecyl (meth)acrylate, isotridecyl (meth)acrylate, isopentadecyl (meth)acrylate, isohexadecyl (meth)acrylate, isoheptadecyl (meth)acrylate, isostearyl (meth)acrylate, and decyltetradecanyl (meth)acrylate.

Examples of an alkyl (meth)acrylate having a cyclic alkyl group (cycloalkyl group) include cyclohexyl (meth)acrylate, 3,3,5-trimethylcyclohexyl (meth)acrylate, isobornyl (meth)acrylate, terpene (meth)acrylate, and dicyclopentanyl (meth)acrylate.

Examples of a compound having one (meth)acryloyl group and an aromatic hydrocarbon group include benzyl (meth)acrylate.

Examples of a compound having one (meth)acryloyl group and a group containing a polyoxyalkylene chain include polyethylene glycol (meth)acrylate, methoxy polyethylene glycol (meth)acrylate, polypropylene glycol (meth)acrylate, methoxy polypropylene glycol (meth)acrylate, polybutylene glycol (meth)acrylate, and methoxy polybutylene glycol (meth)acrylate.

Examples of a compound having one (meth)acryloyl group and a group containing a heterocyclic ring include N-acryloylmorpholine (ACMO) and tetrahydrofurfuryl (meth)acrylate.

Examples of a compound having one (meth)acryloyl group and an alkoxy group include 2-methoxyethyl acrylate.

Examples of a compound having one (meth)acryloyl group and a phenoxy group include phenoxyethyl (meth)acrylate.

Examples of a compound having one (meth)acryloyl group and a group containing a silane group include 3-acryloxypropyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Examples of a compound having one (meth)acryloyl group and a group containing a siloxane bond include silicone (meth)acrylate.

Examples of a compound having one (meth)acryloyl group and a halogen atom include a (meth)acrylate having a fluorine atom.

Examples of a (meth)acrylate having a fluorine atom include trifluoromethyl (meth)acrylate, 2,2,2-trifluoroethyl (meth)acrylate, 1,1,1,3,3,3-hexafluoro-2-propyl (meth)acrylate, perfluoroethylmethyl (meth)acrylate, perfluoropropylmethyl (meth)acrylate, perfluorobutylmethyl (meth)acrylate, perfluoropentylmethyl (meth)acrylate, perfluorohexylmethyl (meth)acrylate, perfluoroheptylmethyl (meth)acrylate, perfluorooctylmethyl (meth)acrylate, perfluorononylmethyl (meth)acrylate, perfluorodecylmethyl (meth)acrylate, perfluoroundecylmethyl (meth)acrylate, perfluorododecylmethyl (meth)acrylate, perfluorotridecylmethyl (meth)acrylate, perfluorotetradecylmethyl (meth)acrylate, 2-(trifluoromethyl)ethyl (meth)acrylate, 2-(perfluoroethyl)ethyl (meth)acrylate, 2-(perfluoropropyl)ethyl (meth)acrylate, 2-(perfluorobutyl)ethyl (meth)acrylate, 2-(perfluoropentyl)ethyl (meth)acrylate, 2-(perfluorohexyl)ethyl (meth)acrylate, 2-(perfluoroheptyl)ethyl (meth)acrylate, 2-(perfluorooctyl)ethyl (meth)acrylate, 2-(perfluorononyl)ethyl (meth)acrylate, 2-(perfluorotridecyl)ethyl (meth)acrylate, and 2-(perfluorotetradecyl)ethyl (meth)acrylate.

Examples of a compound having one (meth)acryloyl group and a hydroxyl group include a hydroxyalkyl (meth)acrylate and a hydroxyalkylcycloalkane (meth)acrylate. Examples of the hydroxyalkyl (meth)acrylate include such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate. Examples of the hydroxyalkylcycloalkane (meth)acrylate include (4-hydroxymethylcyclohexyl)methyl (meth)acrylate.

Examples of a compound having one (meth)acryloyl group and a carboxyl group include (meth)acrylic acid, carboxyethyl (meth)acrylate, carboxypentyl (meth)acrylate, phthalic acid monohydroxyethyl acrylate (for example, “ARONIX M5400” manufactured by TOAGOSEI CO., LTD.), and 2-acryloyloxyethyl succinate (for example, “NK ESTER A-SA” manufactured by SHIN-NAKAMURA CHEMICAL Co., Ltd.).

When the composition further contains a compound having one (meth)acryloyl group, from the viewpoint that the cured product has more excellent thermal conduction properties, it is preferable that the compound having one (meth)acryloyl group contains a compound having one (meth)acryloyl group and a carboxyl group. The content of the compound having one (meth)acryloyl group and a carboxyl group is preferably 8% by mass or less, more preferably 6% by mass or less, and even more preferably 4% by mass or less, based on the total mass of the compound having one (meth)acryloyl group. The content of the compound having one (meth)acryloyl group and a carboxyl group may be 1% by mass or more based on the total mass of the compound having one (meth)acryloyl group.

Examples of a compound having one (meth)acryloyl group and an amino group include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate.

Examples of a compound having one (meth)acryloyl group and an epoxy group include glycidyl (meth)acrylate, glycidyl α-ethyl (meth)acrylate, glycidyl α-n-propyl (meth)acrylate, glycidyl α-n-butyl (meth)acrylate, 3,4-epoxybutyl (meth)acrylate, 4,5-epoxypentyl (meth)acrylate, 6,7-epoxyheptyl (meth)acrylate, 6,7-epoxyheptyl α-ethyl (meth)acrylate, 3-methyl-3,4-epoxybutyl (meth)acrylate, 4-methyl-4,5-epoxypentyl (meth)acrylate, 5-methyl-5,6-epoxyhexyl (meth)acrylate, β-methylglycidyl (meth)acrylate, and β-methylglycidyl α-ethyl (meth)acrylate.

The compound having one (meth)acryloyl group may be a (meth)acrylic polymer having one (meth)acryloyl group at one end of a poly(meth)acrylate chain. Examples of such a (meth)acrylic polymer include “MM110C” manufactured by KANEKA CORPORATION.

The content of the additional polymerizable compound may be 1% by mass or more, 2% by mass or more, 3% by mass or more, 4% by mass or more, or 5% by mass or more, and may be 15% by mass or less, 10% by mass or less, 8% by mass or less, or 7% by mass or less, based on the total mass of the composition.

The content of the other polymerizable compound may be 35 parts by mass or more, 40 parts by mass or more, 45 parts by mass or more, or 50 parts by mass or more, and may be 90 parts by mass or less, 80 parts by mass or less, 70 parts by mass or less, or 60 parts by mass or less, with respect to 100 parts by mass of the total content of the polymerizable components.

The composition may further contain a polymerization initiator. The polymerization initiator may be, for example, a thermal polymerization initiator generating radicals by heat, or a photopolymerization initiator generating radicals by light. The polymerization initiator is preferably a thermal polymerization initiator.

When the composition contains a thermal polymerization initiator, a cured product of the composition can be obtained by adding heat to the composition. In this case, the composition may be a composition that is cured by heating preferably at 105° C. or higher, more preferably 110° C. or higher, and even more preferably 115° C. or higher, and may be a composition that is cured by heating at, for example, 200° C. or lower, 190° C. or lower, or 180° C. or lower. The heating time when heating the composition may be appropriately selected according to the composition of the composition so that the composition is suitably cured.

Examples of the thermal polymerization initiator include an azo compound and an organic peroxide. Examples of the azo compound include azobisisobutyronitrile, azobis-4-methoxy-2,4-dimethylvaleronitrile, azobiscyclohexanone-1-carbonitrile, and azodibenzoyl. Examples of the organic peroxide include benzoyl peroxide, lauroyl peroxide, di-t-butyl peroxide, di-t-hexyl peroxide, di-t-butyl peroxyhexahydroterephthalate, t-butyl peroxy-2-ethylhexanoate, 1,1-t-butyl peroxy-3,3,5-trimethylcyclohexane, and t-butyl peroxyisopropyl carbonate. Regarding the thermal polymerization initiator, these may be used singly or in combination of two or more kinds thereof.

When the composition contains a photopolymerization initiator, a cured product of the composition can be obtained by, for example, irradiating the composition with light (for example, light containing at least a portion of wavelengths of 200 to 400 nm (ultraviolet light)). The conditions for light irradiation may be appropriately set according to the type of the photopolymerization initiator.

The photopolymerization initiator may be, for example, a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, or an acylphosphine oxide-based photopolymerization initiator.

Examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (for example, “IRGACURE 651” manufactured by BASF), and anisole methyl ether. Examples of the acetophenone-based photopolymerization initiator include 1-hydroxycyclohexyl phenyl ketone (for example, “IRGACURE 184” manufactured by BASF), 4-phenoxydichloroacetophenone, 4-t-butyl dichloroacetophenone, 1-[4-(2-hydroxyethoxy)-phenyl]-2-hydroxy-2-methyl-1-propan-1-one (for example, “IRGACURE 2959” manufactured by BASF), 2-hydroxy-2-methyl-1-phenyl-propan-1-one (for example, “IRGACURE 1173” manufactured by BASF), and methoxyacetophenone.

Examples of the α-ketol-based photopolymerization initiator include 2-methyl-2-hydroxypropiophenone and 1-[4-(2-hydroxyethyl)-phenyl]-2-hydroxy-2-methylpropan-1-one. Examples of the aromatic sulfonyl chloride-based photopolymerization initiator include 2-naphthalenesulfonyl chloride. Examples of the photoactive oxime-based photopolymerization initiator include 1-phenyl-1,1-propanedione-2-(o-ethoxycarbonyl)-oxime.

Examples of the benzoin-based photopolymerization initiator include benzoin. Examples of the benzil-based photopolymerization initiator include benzil. Examples of the benzophenone-based photopolymerization initiator include benzophenone, benzoylbenzoic acid, 3,3′-dimethyl-4-methoxybenzophenone, polyvinylbenzophenone, and α-hydroxycyclohexyl phenyl ketone. Examples of the ketal-based photopolymerization initiator include benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Examples of the acylphosphine oxide-based photopolymerization initiator include bis(2,6-dimethoxybenzoyl)phenylphosphine oxide, bis(2,6-dimethoxybenzoyl) (2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl) (2-methylpropan-1-yl)phosphine oxide, bis(2-methoxybenzoyl) (1-methylpropan-1-yl)phosphine oxide, bis(2,6-diethoxybenzoyl) (2-methylpropan-1-yl)phosphine oxide, bis(2,6-diethoxybenzoyl) (1-methylpropan-1-yl)phosphine oxide, bis(2,6-dibutoxybenzoyl) (2-methylpropan-1-yl)phosphine oxide, bis(2,4-dimethoxybenzoyl) (2-methylpropan-1-yl)phosphine oxide, bis(2,4,6-trimethylbenzoyl) (2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoylbenzylbutylphosphine oxide, 2,6-dimethoxybenzoylbenzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

Regarding the above-mentioned photopolymerization initiators, one kind thereof may be used alone, or two or more kinds thereof may be used in combination.

From the viewpoint of suitably carrying out polymerization, the content of the polymerization initiator is preferably 0.01 parts by mass or more, more preferably 0.05 parts by mass or more, even more preferably 0.1 parts by mass or more, and particularly preferably 0.5 parts by mass or more, with respect to 100 parts by mass of the total content of polymerizable components. From the viewpoint that the molecular weight of the polymer in a cured product of the composition is in a suitable range and at the same time, a decomposition product is suppressed, the content of the polymerization initiator is preferably 10 parts by mass or less, more preferably 5 parts by mass or less, and even more preferably 3 parts by mass or less, with respect to 100 parts by mass of the total content of polymerizable components.

The composition may further contain a copolymer containing methyl (meth)acrylate and an alkyl (meth)acrylate having an alkyl group having 2 to 12 carbon atoms (hereinafter, also referred to as “C2-C12 alkyl (meth)acrylate”) as monomer units (hereinafter, also referred to as “acrylic copolymer”). However, this acrylic copolymer does not have a (meth)acryloyl group.

The content of methyl (meth)acrylate contained in the acrylic copolymer may be 5% by mass or more, 10% by mass or more, 13% by mass or more, or 15% by mass or more, and may be 70% by mass or less, 60% by mass or less, 50% by mass or less, 40% by mass or less, 35% by mass or less, 30% by mass or less, or 25% by mass or less, based on the total mass of the monomer units contained in the acrylic copolymer (hereinafter, also simply referred to as “total mass of the monomer units”).

The number of carbon atoms of the alkyl group in the C2-C12 alkyl (meth)acrylate may be 3 or more and may be 8 or less, 7 or less, or 6 or less. This alkyl group may be linear, may be branched, or may be cyclic.

In a case where the alkyl group in the C2-C12 alkyl (meth)acrylate is linear, specific examples thereof include ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate octyl (meth)acrylate, n-nonyl (meth)acrylate, n-decyl (meth)acrylate, and lauryl (meth)acrylate. In a case where the alkyl group in the C2-C12 alkyl (meth)acrylate is branched, specific examples thereof include isopropyl (meth)acrylate, s-butyl (meth)acrylate, t-butyl (meth)acrylate, isobutyl (meth)acrylate, isopentyl (meth)acrylate, isohexyl (meth)acrylate, isoheptyl (meth)acrylate, isooctyl (meth)acrylate, 2-ethylhexyl (meth)acrylate, isononyl (meth)acrylate, and isodecyl (meth)acrylate. In a case where the alkyl group in the C2-C12 alkyl (meth)acrylate is cyclic (cycloalkyl group), specific examples thereof include cyclohexyl (meth)acrylate.

The above-mentioned C2-C12 alkyl (meth)acrylates may be used singly or in combination of two or more kinds thereof.

The content of the C2-C12 alkyl (meth)acrylate contained in the acrylic copolymer may be 30% by mass or more, 50% by mass or more, 60% by mass or more, 70% by mass or more, or 75% by mass or more, and may be 95% by mass or less, 90% by mass or less, or 85% by mass or less, based on the total mass of the monomer units.

The acrylic copolymer may contain only methyl (meth)acrylate and a C2-C12 alkyl (meth)acrylate as the monomer units, and may further contain an additional monomer unit that can be copolymerized with methyl (meth)acrylate and the C2-C12 alkyl (meth)acrylate.

Examples of the additional monomer unit include a carboxyl group-containing monomer, a hydroxyl group-containing monomer, an isocyanate group-containing monomer, an amino group-containing monomer, and an epoxy group-containing monomer.

Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. Examples of the hydroxyl group-containing monomer include 2-hydroxyethyl (meth)acrylate, 3-hydroxypropyl (meth)acrylate, 4-hydroxybutyl (meth)acrylate, 6-hydroxyhexyl (meth)acrylate, 8-hydroxyocthyl (meth)acrylate, 10-hydroxydecyl (meth)acrylate, and 12-hydroxylauryl (meth)acrylate. Examples of the isocyanate group-containing monomer include 2-methacryloyloxyethyl isocyanate and 2-acryloxyethyl isocyanate. Examples of the amino group-containing monomer include N,N-dimethylaminoethyl (meth)acrylate, N,N-diethylaminoethyl (meth)acrylate, N,N-dimethylaminopropyl (meth)acrylate, and N,N-diethylaminopropyl (meth)acrylate. Examples of the epoxy group-containing monomer include glycidyl (meth)acrylate, glycidyl α-ethyl (meth)acrylate, glycidyl α-n-propyl (meth)acrylate, glycidyl α-n-butyl (meth)acrylate, 3,4-epoxybutyl (meth)acrylate, 4,5-epoxypentyl (meth)acrylate, 6,7-epoxyheptyl (meth)acrylate, 6,7-epoxyheptyl α-ethyl (meth)acrylate, 3-methyl-3,4-epoxybutyl (meth)acrylate, 4-methyl-4,5-epoxypentyl (meth)acrylate, 5-methyl-5,6-epoxyhexyl (meth)acrylate, β-methylglycidyl (meth)acrylate, and β-methylglycidyl α-ethyl (meth)acrylate. The content of the additional monomer unit may be 10% by mass or less, 5% by mass or less, 3% by mass or less, or 1% by mass or less, based on the total mass of the monomer units.

The acrylic copolymer may be an alternating copolymer, a block copolymer, or a random copolymer, each containing a methyl (meth)acrylate unit, a C2-C12 alkyl (meth)acrylate unit, and optionally an additional monomer unit, and the acrylic copolymer is preferably a block copolymer.

The block copolymer may have a block containing a methyl (meth)acrylate unit (hereinafter, also referred to as “first block”) and a block containing a C2-C12 alkyl (meth)acrylate (hereinafter, also referred to as “second block”).

The content of the methyl (meth)acrylate contained in the first block may be 90% by mass or more, 95% by mass or more, or 99% by mass or more, based on the total mass of the monomer units contained in the first block. The first block may be, for example, a polymethyl (meth)acrylate block containing only methyl (meth)acrylate as the monomer unit.

The content of the C2-C12 alkyl (meth)acrylate contained in the second block may be 90% by mass or more, 95% by mass or more, or 99% by mass or more, based on the total mass of the monomer units contained in the second block. The second block may contain one kind selected from C2-C12 alkyl (meth)acrylates, or may contain two or more kinds thereof, as the monomer unit. The second block may be, for example, a poly-n-butyl (meth)acrylate block containing only n-butyl (meth)acrylate as the monomer unit.

The block copolymer may be a diblock copolymer in which the first block and the second block are bonded in this order, or may be a triblock copolymer in which the first block, the second block, and the first block are bonded in this order.

The content of the acrylic copolymer may be 0.05% by mass or more, 0.1% by mass or more, or 0.15% by mass or more, and may be 1% by mass or less, 0.7% by mass or less, or 0.5% by mass or less, based on the total mass of the composition.

The content of the acrylic copolymer may be 1 part by mass or more, 2 parts by mass or more, or 3 parts by mass or more, and may be 10 parts by mass or less, 7 parts by mass or less, or 6 parts by mass or less, with respect to 100 parts by mass of the total content of the polymerizable components.

The composition may further contain an antioxidant, from the viewpoint of improving the thermal reliability of the cured product. The antioxidant may be, for example, a phenol-based antioxidant, a benzophenone-based antioxidant, a benzoate-based antioxidant, a hindered amine-based antioxidant, or a benzotriazole-based antioxidant, and the antioxidant is preferably a phenol-based antioxidant.

A phenol-based antioxidant has, for example, a hindered phenol structure (hindered phenol ring). The hindered phenol structure (hindered phenol ring) may be, for example, a structure in which a t-butyl group is bonded to one or both of the positions ortho to the hydroxyl group on the phenol ring. The phenol-based antioxidant has one or more of such hindered phenol rings and preferably has two or more, more preferably three or more, and even more preferably four or more, hindered phenol rings.

The content of the antioxidant may be 0.1% by mass or more, 0.2% by mass or more, or 0.3% by mass or more, and may be 5% by mass or less, 3% by mass or less, 1% by mass or less, or 0.7% by mass or less, based on the total mass of the composition.

The composition can further contain additional additives as necessary. Examples of the additional additives include a thixotropy-imparting agent, a surface treatment agent, a dispersant, a curing accelerator, a colorant, a crystal nucleating agent, a thermal stabilizer, a foaming agent, a flame retardant, a damping agent, a dehydrating agent, and a flame-retardant aid (for example, a metal oxide). The content of the other additives may be 0.1% by mass or more and may be 1% by mass or less, based on the total mass of the composition.

The composition is preferably liquid at 25° C. Thereby, the composition can be suitably applied on the surface of an object such as a member serving as a heat source or a cooling member, and the adhesiveness to the coating surface can also be enhanced. The composition may also be solid at 25° C., and in that case, it is preferable that the composition becomes liquid by heating (for example, at 50° C. or higher).

### [Composition Set]

The above-mentioned composition may be in a state of a multi-liquid type composition (composition set). A composition set according to an embodiment is a composition set containing a first liquid containing an oxidizing agent and a second liquid containing a reducing agent. At least one of the first liquid and the second liquid contains the above-mentioned (meth)acrylic polymer. Furthermore, at least one of the first liquid and the second liquid contains the above-mentioned metal particles. By mixing the first liquid and the second liquid, the oxidizing agent and the reducing agent react with each other to generate free radicals, and polymerization of the polymerizable components such as the (meth)acrylic polymer proceeds. According to the composition set related to the present embodiment, when mixing the first liquid and the second liquid, a cured product of a mixture of the first liquid and the second liquid can be obtained immediately. That is, according to the composition set, a cured product of the composition is obtained at a rapid rate.

In the composition set, preferably, the first liquid contains an oxidizing agent, a (meth)acrylic polymer, and metal particles, and the second liquid contains a reducing agent, a (meth)acrylic polymer, and metal particles.

The content of the (meth)acrylic polymer based on the total mass of the liquids constituting the composition set (for example, in a case of a two-liquid type composition set, the total amount of the first liquid and the second liquid) may be the same as the above-mentioned range of the content of the (meth)acrylic polymer based on the total mass of the composition. The same also applies to the content of the metal particles contained in the composition set.

The oxidizing agent contained in the first liquid has a role as a polymerization initiator (radical polymerization initiator). The oxidizing agent may be, for example, an organic peroxide or an azo compound. The organic peroxide may be, for example, a hydroperoxide, a peroxydicarbonate, a peroxy ester, a peroxy ketal, a dialkyl peroxide, or a diacyl peroxide. The azo compound may be AIBN (2,2′-azobisisobutyronitrile), V-65 (azobisdimethylvaleronitrile), or the like. The oxidizing agents can be used singly or in combination of two or more kinds thereof.

Examples of the hydroperoxide include diisopropylbenzene hydroperoxide and cumene hydroperoxide.

Examples of the peroxydicarbonate include di-n-propyl peroxydicarbonate, diisopropyl peroxydicarbonate, bis(4-t-butylcyclohexyl) peroxydicarbonate, di-2-ethoxymethoxy peroxydicarbonate, di(2-ethylhexylperoxy) dicarbonate, dimethoxybutyl peroxydicarbonate, and di(3-methyl-3-methoxybutylperoxy) dicarbonate.

Examples of the peroxy ester include cumyl peroxyneodecanoate, 1,1,3,3-tetramethylbutyl peroxyneodecanoate, 1-cyclohexyl 1-methylethyl peroxyneodecanoate, t-hexyl peroxyneodecanoate, t-butyl peroxypivalate, 1,1,3,3-tetramethylbutyl peroxy-2-ethylhexanonate, 2,5-dimethyl-2,5-di(2-ethylhexanoylperoxy)hexane, 1-cyclohexyl-1-methylethyl peroxy-2-ethylhexanonate, t-hexyl peroxy-2-ethylhexanonate, t-butyl peroxy-2-ethylhexanonate, t-butyl peroxyisobutyrate, 1,1-bis(t-butylperoxy)cyclohexane, t-butyl peroxy-3,5,5-trimethylhexanonate, t-butyl peroxylaurate, 2,5-dimethyl-2,5-di(m-toluoylperoxy)hexane, t-hexyl peroxybenzoate, and t-butyl peroxyacetate.

Examples of the peroxy ketal include 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)cyclododecane, and 2,2-bis(t-butylperoxy)decane.

Examples of the dialkyl peroxide include α,α′-bis(t-butylperoxy)diisopropylbenzene, dicumyl peroxide, 2,5-dimethyl-2,5-di(t-butylperoxy)hexane, and t-butylcumyl peroxide.

Examples of the diacyl peroxide include isobutyl peroxide, 2,4-dichlorobenzoyl peroxide, 3,5,5-trimethylhexanoyl peroxide, octanoyl peroxide, lauroyl peroxide, stearoyl peroxide, succinic peroxide, benzoylperoxytoluene, and benzoyl peroxide.

From the viewpoint of storage stability, the oxidizing agent is preferably a peroxide, more preferably a hydroperoxide, and even more preferably cumene hydroperoxide.

The content of the oxidizing agent may be 0.1% by mass or more, 0.5% by mass or more, or 1% by mass or more, and may be 10% by mass or less, 5% by mass or less, or 3% by mass or less, based on the total mass of the liquids constituting the composition set.

The reducing agent contained in the second liquid may be, for example, a tertiary amine, a thiourea derivative, or a transition metal salt. Examples of the tertiary amine include triethylamine, tripropylamine, tributylamine, and N,N-dimethyl-para-toluidine. Examples of the thiourea derivative include 2-mercaptobenzimidazole, methylthiourea, dibutylthiourea, tetramethylthiourea, and ethylenethiourea. Examples of the transition metal salt include cobalt naphthenate, copper naphthenate, and vanadyl acetylacetonate. The reducing agents can be used singly or in combination of two or more kinds thereof.

The reducing agent is preferably a thiourea derivative or a transition metal salt, from the viewpoint of having an excellent curing rate. The thiourea derivative may be, for example, ethylene thiourea. From the same viewpoint, the transition metal salt is preferably vanadyl acetylacetonate.

The content of the reducing agent may be 0.05% by mass or more, 0.1% by mass or more, or 0.3% by mass or more, and may be 5% by mass or less, 3% by mass or less, or 1% by mass or less, based on the total mass of the liquids constituting the composition set.

The composition set may further contain an additional polymerizable compound, an acrylic copolymer, an antioxidant, and additional additives, all of which can be used for the above-mentioned composition. These components may be contained in one or both of the first liquid and the second liquid or may be contained in a third liquid different from the first liquid and the second liquid. The contents of these components based on the total mass of the liquids constituting the composition set may be the same as the above-mentioned ranges of the contents of these components based on the total mass of the composition.

Since the cured products of the above-mentioned composition and composition set, have thermal conduction properties and have excellent heat resistance, the composition and the composition set are suitable for use applications such as a heat dissipation material, an adhesive, a die attach material, a structural bonding adhesive, a binder for batteries, a stress relieving agent, a sealing agent, a coating agent, and a paint and are particularly suitably used as compositions for forming a heat dissipation material. Similarly, a cured product of the above-mentioned composition and a cured product of a mixture of the composition set have excellent heat resistance and are therefore suitable for each of the above-described use applications. Specifically, a cured product of the above-mentioned composition and a cured product of the composition set can be suitably used as heat dissipation materials for semiconductor components, and can be suitably used particularly for heat dissipation use applications for semiconductor packages that are used in personal computers, servers, base stations, and the like.

### [Article]

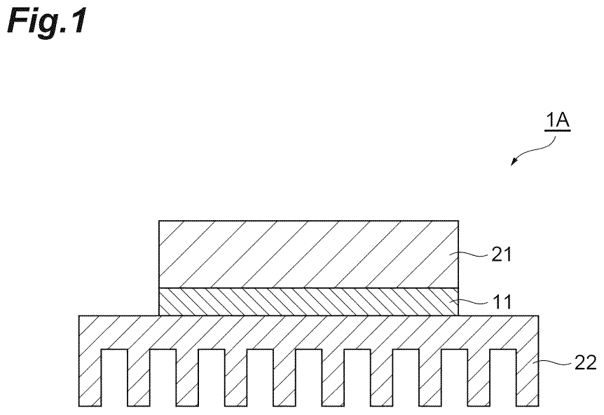

Subsequently, an article containing a cured product of the above-mentioned composition or composition set (hereinafter, also simply referred to as “cured product”) will be described. An article according to an embodiment contains a heat source and a cured product in thermal contact with the heat source. Hereinafter, as a more specific example of the article, an electronic component will be taken as an example and described. FIG. 1 is a schematic cross-sectional view illustrating an embodiment of an electronic component containing a cured product. The electronic component 1A shown in FIG. 1 contains a semiconductor chip 21 as a heat source and a heat sink 22 as a heat dissipation part.

The electronic component 1A contains a cured product 11 provided between the semiconductor chip 21 and the heat sink 22. The cured product 11 is a cured product of the above-mentioned composition, or a cured product of a mixture of the composition set.

Since the cured product 11 has thermal conduction properties, the cured product 11 works as a thermally conductive material (thermal interface material) for the electronic component 1A, and heat is transferred from the semiconductor chip 21 to the heat sink 22. Then, heat is dissipated to the outside from the heat sink 22.

Since the cured product 11 has excellent heat resistance, deterioration caused by heat is suppressed. Therefore, the heat generated from the semiconductor chip 21 can be effectively transferred to the heat sink 22.

The cured product 11 can also be obtained by disposing a liquid composition (composition set) between the semiconductor chip 21 and the heat sink 22 and then curing the composition (composition set). For that reason, generation of voids by dripping and the pump-out phenomenon can be suppressed, and as a result, excellent adhesiveness of the cured product 11 (adhesiveness to the surfaces of the semiconductor chip 21 and the heat sink 22) can be obtained. Incidentally, the curing means and curing conditions for the composition may be adjusted according to the composition of the composition, or the type of the polymerization initiator.

In the electronic component 1A explained in FIG. 1, the cured product 11 is disposed to be in direct contact with the semiconductor chip 21 and the heat sink 22; however, it is acceptable as long as the cured product 11 is in thermal contact with a heat source, and in another embodiment, the cured product 11 may be disposed to be in contact with a heat source (semiconductor chip), with another member interposed therebetween.

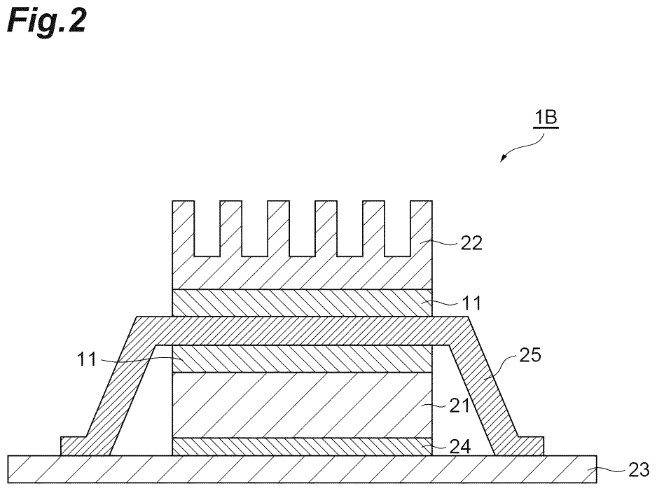

FIG. 2 is a schematic cross-sectional view illustrating another embodiment of the electronic component containing a cured product. The electronic component 1B shown in FIG. 2 is a processor containing, on one surface of a substrate 23, a semiconductor chip 21 as a heat source disposed with an underfill 24 interposed therebetween, a heat sink 22 as a heat dissipation part, and a heat spreader 25 provided between the semiconductor chip 21 and the heat sink 22. Between the semiconductor chip 21 and the heat spreader 25, a first cured product 11 provided to be in contact with the semiconductor chip 21 is provided. Between the heat spreader 25 and the heat sink 22, a second cured product 11 is provided.

The substrate 23, underfill 24, and heat spreader 25 may be formed from materials that are generally used in the art. For example, the substrate 23 may be a laminated substrate or the like, the underfill 24 may be formed from a resin such as an epoxy resin, or the like, and the heat spreader 25 may be a metal plate or the like.

The first cured product 11 and the second cured product 11 are cured products of the above-mentioned curable composition or cured products of a mixture of the above-mentioned curable composition set. The first cured product 11 is in direct contact with the semiconductor chip 21 as a heat source, while the second cured product 11 is in thermal contact with the semiconductor chip 21 as a heat source, with the first cured product 11 and the heat spreader 25 interposed therebetween.

Since the first cured product 11 and the second cured product 11 have thermal conduction properties, the first cured product 11 and the second cured product 11 work as thermally conductive materials (thermal interface materials) for the electronic component 1B. That is, the first cured product 11 promotes heat transfer from the semiconductor chip 21 to the heat spreader 25. Furthermore, the second cured product 11 promotes heat transfer from the heat spreader 25 to the heat sink 22. Then, heat is dissipated to the outside from the heat sink 22.

Since the first cured product 11 and the second cured product 11 also have excellent heat resistance, deterioration of the first cured product 11 and the second cured product 11 caused by heat is suppressed. Therefore, the heat generated from the semiconductor chip 21 can be transferred more effectively to the heat spreader 25, and the heat can be transferred more effectively to the heat sink 22.

The first cured product 11 and the second cured product 11 can also be obtained by disposing a liquid composition (composition set) between the semiconductor chip 21 and the heat spreader 25 or between the heat spreader 25 and the heat sink 22, and then curing the composition (composition set). For that reason, also for the electronic component 1B, generation of voids by dripping and the pump-out phenomenon of the composition (composition set) can be suppressed, and as a result, excellent adhesiveness of the first cured product 11 and the second cured product 11 (adhesiveness to the surfaces of the semiconductor chip 21, heat spreader 25, and/or heat sink 22) can be obtained.

### Examples

Hereinafter, the present invention will be described more specifically based on Examples. The present invention is not intended to be limited to these Examples.

In Examples and Comparative Examples, each of the following components was used.
(A-1) A (meth)acrylic polymer having (meth)acryloyl groups at both ends of a poly(meth)acrylate chain (“RC200C” manufactured by KANEKA CORPORATION, weight average molecular weight: 18000, viscosity at 23° C.: 530 Pa·s, Tg: −39° C.)
(A-2) A (meth)acrylic polymer having (meth)acryloyl groups at both ends of a poly(meth)acrylate chain (“RC100C” manufactured by KANEKA CORPORATION, weight average molecular weight: 20000, viscosity at 23° C.: 160 Pa·s, Tg: −50° C.)
(A-3) A (meth)acrylic polymer having (meth)acryloyl groups at both ends of a poly(meth)acrylate chain (“RC310C” manufactured by KANEKA CORPORATION, weight average molecular weight: 30000, viscosity at 23° C.: 760 Pa·s, Tg: −44° C.)
(A-4) A (meth)acrylic polymer having (meth)acryloyl groups at both ends of a poly(meth)acrylate chain (“RC120C” manufactured by KANEKA CORPORATION, weight average molecular weight: 30000, viscosity at 23° C.: 330 Pa·s, Tg: −50° C.)
(a-1) A compound represented by the following Formula (a-1) (weight average molecular weight: 16000, mixture in which m in the Formula (a-1) is an integer of approximately 246±5 and n is an integer of approximately 105±5, viscosity at 25° C.: 55 Pa·s)

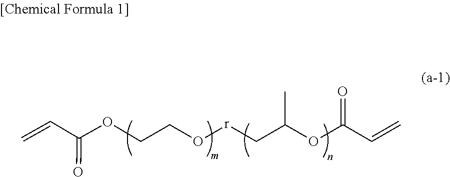

In the Formula (a-1), -r- is a symbol representing random copolymerization.
(B-1) Flaky silver particles (“SILCOAT AgC-221PA” manufactured by FUKUDA METAL CO., LTD., average particle size: 6.8 μm, BET specific surface area: 0.20 m²/g)
(B-2) Flaky silver particles (“SILCOAT AgC-2262” manufactured by FUKUDA METAL CO., LTD., average particle size: 5.3 μm, BET specific surface area 0.1 to 0.4 m²/g)
(C-1) 2-Ethylhexyl acrylate (“AEH” manufactured by NIPPON SHOKUBAI CO., LTD.)
(C-2) Isodecyl acrylate (“FA111A” manufactured by Showa Denko Materials Co., Ltd.)
(C-3) 4-Hydroxybutyl acrylate (manufactured by OSAKA ORGANIC CHEMICAL INDUSTRY, LTD.)
(C-4) N-acryloylmorpholine (“ACMO” manufactured by KJ Chemicals Corporation)
(C-5) 2-Acryloyloxyethyl succinate (“NK ESTER A-SA” manufactured by SHIN-NAKAMURA CHEMICAL Co., Ltd.)
(D-1) A triblock copolymer in which a polymethyl methacrylate block, a poly-n-butyl acrylate block, and a polymethyl methacrylate block are bonded in this order (“KURARITY (registered trademark) LA2270” manufactured by Kuraray Co., Ltd., content of methyl methacrylate based on the total mass of monomer units: 40% by mass, weight average molecular weight: about 50000)
(D-2) A triblock copolymer in which a polymethyl methacrylate block, a poly-n-butyl acrylate block, and a polymethyl methacrylate block are bonded in this order (“KURARITY (registered trademark) LA2140” manufactured by Kuraray Co., Ltd., content of methyl methacrylate based on the total mass of monomer units: 20% by mass, weight average molecular weight: about 47000)
(D-3) A triblock copolymer in which a polymethyl methacrylate block, a poly-n-butyl acrylate block, and a polymethyl methacrylate block are bonded in this order (“KURARITY (registered trademark) LA3710” manufactured by Kuraray Co., Ltd., content of methyl methacrylate based on the total mass of monomer units: 15% by mass, weight average molecular weight: 150000)
(E) Phenol-based antioxidant (“Irganox 1010” manufactured by BASF Japan Ltd.)
(F) Thixotropy-imparting agent (“GARAMITE-7305” manufactured by BYK)
(G) Thixotropy-imparting agent (“FLOWLEN GW1500” manufactured by Kyoeisha Chemical Co., Ltd.)

### [Production of Composition and Cured Product]

The components were mixed at the blending ratio indicated in Table 1, and a composition of each Example was obtained.

Furthermore, the composition of each Example was charged into a mold form (made of SUS plates) having a size of 10 cm×10 cm×0.5 mm, the mold form was covered with a SUS plate, the composition was heated for 15 minutes under the conditions of 135° C. to be cured, and thereby a cured product having a thickness of 0.5 mm was obtained.

### [Evaluation of Heat Resistance]

A cured product having a thickness of 0.5 mm was cut into a size of 3 cm×3 cm, the weight (initial weight) was measured, subsequently the cured product was placed in a constant temperature bath at 150° C. and taken out after 1000 hours, and the weight (weight after 1000 hours) was measured again. The amount of weight loss was determined by the following formula.

$$Amount of weight loss ( \% ) = \{ ( Initial weight - weight after 1000 hours ) / inital weight \times 100$$

### [Measurement of Thermal Conductivity]

A cured product having a thickness of 0.5 mm was cut into a square shape having a size of 10 mm×10 mm×0.5 mm and subjected to a blackening treatment with a graphite spray, and then the thermal diffusivity under the conditions of 25° C. was measured by a xenon flash method (“LFA447 nanoflash” manufactured by NETZSCH-Geratebau GmbH, Selb/Bayern). From the product of this value, the density measured by the Archimedean method, and the specific heat at 25° C. measured with a differential scanning calorimeter (“DSC250” manufactured by TA Instruments, Inc.), the thermal conductivity in the thickness direction of the cured product was determined based on the following formula.

$$Thermal conductivity λ ( W / ( m \cdot K ) ) = α \times ρ \times Cp$$

$$α : Thermal diffusivity ( {m}^{2} / s )$$

$$ρ : Density ( kg / {cm}^{3} )$$

$$Cp : Specific heat ( capacity ) ( kJ / ( kg \cdot K ) )$$

### [Measurement of Elongation at Break and Tensile Modulus]

The elongation at break and the tensile modulus of a cured product at 25° C. were measured using a tensile tester (“Autograph EZ-TEST EZ-S” manufactured by SHIMADZU CORPORATION). Regarding the measurement, measurement was performed based on JIS K7161 for a cured product having a shape of 0.5 mm (thickness)×5 mm (width)×30 mm (length), under the conditions of a distance between chucks of 20 mm and a tensile rate of 5 mm/min.

For the cured product of the composition of each Example, the results of measuring each physical property are shown in Table 1 to Table 3.

TABLE 1

| | | Comparative | Example | Example | Example | Example | Example |
|---|---|---|---|---|---|---|---|
| | | Example 1 | 1 | 2 | 3 | 4 | 5 |
| Blending | A-1 | — | 3.90 | — | — | — | — |
| ratio | A-2 | — | — | 3.90 | — | — | — |
| (% by mass) | A-3 | — | — | — | 3.90 | 3.90 | — |
| | A-4 | — | — | — | — | — | 3.90 |
| | a-1 | 2.53 | — | — | — | — | — |
| | B-1 | 89.68 | 89.68 | 89.68 | 89.68 | 89.68 | 89.68 |
| | C-1 | 1.33 | 0.97 | 0.97 | 0.97 | 0.97 | 0.97 |
| | C-2 | 4.00 | 2.92 | 2.92 | 2.92 | 2.92 | 2.92 |
| | C-3 | 0.57 | 0.39 | 0.39 | 0.39 | 0.39 | 0.39 |
| | C-4 | 1.00 | 0.97 | 0.97 | 0.97 | 0.97 | 0.97 |
| | C-5 | 0.01 | 0.10 | 0.10 | 0.10 | 0.10 | 0.10 |
| | D-1 | 0.3 | — | — | — | — | — |
| | D-2 | — | 0.49 | 0.49 | 0.49 | — | — |
| | D-3 | — | — | — | — | 0.49 | 0.49 |
| | E | 0.58 | 0.58 | 0.58 | 0.58 | 0.58 | 0.58 |

| | | | | | | |
|---|---|---|---|---|---|---|
| Content of metal | 45 | 45 | 45 | 45 | 45 | 45 |
| particles (% by volume) | | | | | | |
| Heat resistance (amount | 6.30 | 2.86 | 3.00 | 2.89 | 3.01 | 3.11 |
| of weight loss (%)) | | | | | | |
| Thermal conductivity | 5.7 | 13.2 | 10.1 | 11.2 | 10.5 | 9.5 |
| (W/(m · K)) | | | | | | |
| Elongation at break (%) | 22.0 | 10.6 | 17.9 | 27.8 | 32.0 | 27.0 |
| Tensile modulus (MPa) | 22.0 | 161.6 | 56.7 | 73.2 | 68.0 | 44.4 |

TABLE 2

| | | Example | Example | Example | Example | Example | Example |
|---|---|---|---|---|---|---|---|
| | | 6 | 7 | 8 | 9 | 10 | 11 |
| Blending | A-3 | 3.41 | 3.90 | 3.90 | 3.90 | 3.90 | 3.88 |
| ratio | B-1 | 89.68 | 89.68 | 89.68 | 89.68 | 89.68 | 89.68 |
| (% by mass) | C-1 | 1.07 | 0.97 | 0.88 | 0.97 | 0.88 | 0.97 |
| | C-2 | 3.31 | 2.92 | 2.53 | 2.82 | 2.63 | 2.91 |
| | C-3 | 0.39 | — | 0.88 | 0.39 | 0.39 | 0.39 |
| | C-4 | 0.97 | 1.36 | 0.97 | 0.97 | 0.97 | 0.97 |
| | C-5 | 0.10 | 0.10 | 0.10 | 0.19 | 0.49 | 0.10 |
| | D-3 | 0.49 | 0.49 | 0.49 | 0.49 | 0.49 | 0.48 |
| | E | 0.58 | 0.58 | 0.58 | 0.58 | 0.58 | 0.58 |
| | F | — | — | — | — | — | 0.45 |

| | | | | | | |
|---|---|---|---|---|---|---|
| Content of metal | 45 | 45 | 45 | 45 | 45 | 45 |
| particles (% by volume) | | | | | | |
| Heat resistance (amount | 2.52 | 2.71 | 2.35 | 2.50 | 2.36 | 2.20 |
| of weight loss (%)) | | | | | | |
| Thermal conductivity | 10.1 | 10.0 | 11.2 | 11.7 | 5.8 | 9.0 |
| (W/(m · K)) | | | | | | |
| Elongation at break (%) | 21.7 | 33.6 | 22.0 | 68.5 | 69.9 | 78.1 |
| Tensile modulus (MPa) | 48.8 | 65.2 | 80.2 | 63.3 | 25.5 | 28.4 |

TABLE 3

| | | Example | Example | Example | Example | Example | Example | Example |
|---|---|---|---|---|---|---|---|---|
| | | 12 | 13 | 14 | 15 | 16 | 17 | 18 |
| Blending | A-3 | 4.01 | 4.01 | 3.76 | 3.51 | 4.01 | 3.76 | 4.00 |
| ratio | B-1 | — | 89.68 | 89.68 | 89.68 | 89.68 | 89.68 | 89.41 |
| (% by mass) | B-2 | 89.68 | — | — | — | — | — | — |
| | C-1 | 1.00 | 1.00 | 1.05 | 1.10 | 1.00 | 1.00 | 1.00 |
| | C-2 | 2.91 | 2.91 | 3.11 | 3.31 | 3.01 | 2.91 | 2.90 |
| | C-3 | 0.40 | 0.40 | 0.40 | 0.40 | 0.40 | 0.40 | 0.40 |
| | C-4 | 1.00 | 1.00 | 1.00 | 1.00 | 1.00 | 1.00 | 1.00 |
| | C-5 | 0.20 | 0.20 | 0.20 | 0.20 | 0.10 | 0.20 | 0.20 |
| | D-3 | 0.50 | 0.50 | 0.50 | 0.50 | 0.50 | 0.75 | 0.50 |
| | E | 0.30 | 0.30 | 0.30 | 0.30 | 0.30 | 0.30 | 0.30 |
| | G | — | — | — | — | — | — | 0.3 |

| | | | | | | | |
|---|---|---|---|---|---|---|---|
| Content of metal | 45 | 45 | 45 | 45 | 45 | 45 | 45 |
| particles (% by volume) | | | | | | | |
| Heat resistance (amount | 2.87 | 2.46 | 2.62 | 2.76 | 2.65 | 2.57 | 2.81 |
| of weight loss (%)) | | | | | | | |
| Thermal conductivity | 13.0 | 9.5 | 9.8 | 9.7 | 9.7 | 9.4 | 9.9 |
| (W/(m · K)) | | | | | | | |
| Elongation at break (%) | 41.0 | 104.4 | 92.6 | 90.1 | 37.2 | 109.0 | 51.3 |
| Tensile modulus (MPa) | 80.0 | 41.5 | 59.1 | 48.7 | 75.7 | 64.2 | 61.1 |

### REFERENCE SIGNS LIST

1A, 1B: electronic component, 11: cured product of composition, 21: semiconductor chip (heat source), 22: heat sink, 23: substrate, 24: underfill, 25: heat spreader.

1. A composition comprising:
a (meth)acrylic polymer having (meth)acryloyl groups at both ends of a poly(meth)acrylate chain; and
metal particles.

2. The composition according to claim 1, wherein the (meth)acrylic polymer has a glass transition temperature of −40° C. or lower.

3. The composition according to claim 1, wherein the (meth)acrylic polymer has a weight average molecular weight of 19000 or more.

4. The composition according to claim 2, wherein a viscosity at 23° C. of the (meth)acrylic polymer is 200 Pa·s or greater.

5. The composition according to claim 1, wherein the composition further comprises a compound having one (meth)acryloyl group,
the compound having one (meth)acryloyl group comprises a compound having one (meth)acryloyl group and a carboxyl group, and
a content of the compound having one (meth)acryloyl group and a carboxyl group is 8% by mass or less based on a total mass of the compound having one (meth)acryloyl group.

6. The composition according to claim 1, wherein the metal particles are silver particles.

7. The composition according to claim 6, wherein the composition is used for forming a heat dissipation material.

8. A cured product of the composition according to claim 1.

9. An article comprising:
a heat source; and
the cured product according to claim 8 in thermal contact with the heat source.
